(19) United States
(12) Patent Application Publication
(10) Pub. No.: US 2019/0328019 A1
(43) Pub. Date: Oct. 31, 2019

(54) Olive Oil Pods or O2 Pods

(71) Applicant: Stephanie Ann Green, Milwaukie, OR (US)

(72) Inventor: Stephanie Ann Green, Milwaukie, OR (US)

(21) Appl. No.: 16/189,622

(22) Filed: Nov. 13, 2018

Related U.S. Application Data
(60) Provisional application No. 62/762,244, filed on Apr. 26, 2018.

(51) Int. Cl. A23L 27/00; A23L 27/12; A23P 10/35; A23D 9/04

(52) U.S. Cl. CPC A23L 27/72; A23L 27/12; A23V 2002/00; A23D 9/04; A23P 10/35

(57) ABSTRACT

The purpose of this patent application is to obtain a patent on Olive Oil Pods or also known as O2 Pods. The main purpose for this invention is to benefit the food industry and average consumer. The pods are round or square or oblong, gelatin based food grain product on the outside, filled with Olive Oil and spices/herbs on the inside. The outside of the pod is clear or translucent in color; the inside is yellow in color due to the olive oil, along with many different herbs or spices infused into the olive oil. Olive oil in the tradition bottle is messy and leaves oil residue or stains on surfaces that it touches or drips on. The current state of Olive Oil is via a bottle and when the bottle is touched it is usually laced with greasy oil that will stain counters, clothes or hands. When Olive Oil is poured into the pan, olive oil splashes onto the counter, burner and all over the bottle. Then typically when Olive Oil is done being used, the cook or chef places it back in the pantry further getting more olive oil on hands, clothes, counter and pantry. The Olive Oil Pods will alleviate the mess, while gaining time efficiency in terms of having the Olive Oil already measured out (as they will come in increments of 1 teaspoon, 1 tablespoon, 2 tablespoons etc. . . . ) and already properly spiced.

### CROSS-REFERENCE TO RELATED APPLICATIONS

Per 37 CFR 1.76, Stephanie Ann Green has previously filed a provisional patent application which its number is 62/762,244 with a filing date of Apr. 26, 2018. File Receipt Confirmation number is 1527.

### STATEMENT REGARDING FEDERALLY SPONSORED RESEARCH OR DEVELOPMENT (IF APPLICABLE)

There are no rights to this invention under federally sponsored research and development programs.

### REFERENCE TO SEQUENCE LISTING, A TABLE, OR A COMPUTER PROGRAM LISTING COMPACT DISC APPENDIX

This section is non-applicable to this patent application.

### BACKGROUND OF THE INVENTION

This invention is a new invention in which no patents or ideas already exist. This is a brand new product that will be brought to the market. This invention does not improve any other product on the market. It is a new product and that is standalone. The main impetus for the Olive Oil Pod is to save time and save from a messy clean up. Also the main purpose is so that all can start to enjoy cooking and get their food perfectly spiced with olive oil pods.

Stephanie Ann Green is an avid home chef and cook. Most of her days are spent in the kitchen cooking; while she is not at work or spending time with her three kids. Every time she cooks, she has to open a greasy bottle of olive oil and add it the pan, while dripping olive oil on the side of the pan, onto the burner, on the floor and counter. It is one of those things that as a chef, she dreads. That is when the Olive Oil Pod was invented. Open a jar, pick an olive oil pod with fresh spices infused in the center, and drop it in the pan to start cooking. The pod melts upon the activation of heat, releasing the olive oil and spices. Very simple invention and any spice can be added and any type of olive oil can be used. The options are endless.

### BRIEF SUMMARY OF THE INVENTION

As mentioned above, there is a huge market and need for this product. The invention uses a Gelatin that is a translucent, colorless, brittle (when dry), flavorless food ingredient that is derived from collagen obtained from various animal body parts. Gelatin may also come in the form of olive oil for vegan. It is commonly used as a gelling agent in food, medications, drug and vitamin capsules, photographic films and papers, and cosmetics. The gelatin will be molded to resemble a circle, square or any other type of pod shape and in the center of each pod resides olive oil that is infused with fresh herbs or spices. Any type of olive oil can be used. All and any herb can be infused in the center. Any and all herbs and oils are in scope of this product. The options are endless.

### BRIEF DESCRIPTION OF THE SEVERAL VIEWS OF THE DRAWING

There are two figures in the attached drawings. Each figure shows a top view and side view in order to better visualize the product. There is a FIG. 01 that has two elements labeled (1 and 2). There is a FIG. 02 that has two elements labeled (1 and 2). Below summarizes each figure and details out each component of the figure.

FIG. 01

1=A gelatin, agar agar, or other edible gelatin substance that is used to encapsulate the inside substance.

2=Olive Oil is the inside substance of the encapsulated gelatin pod.

FIG. 02

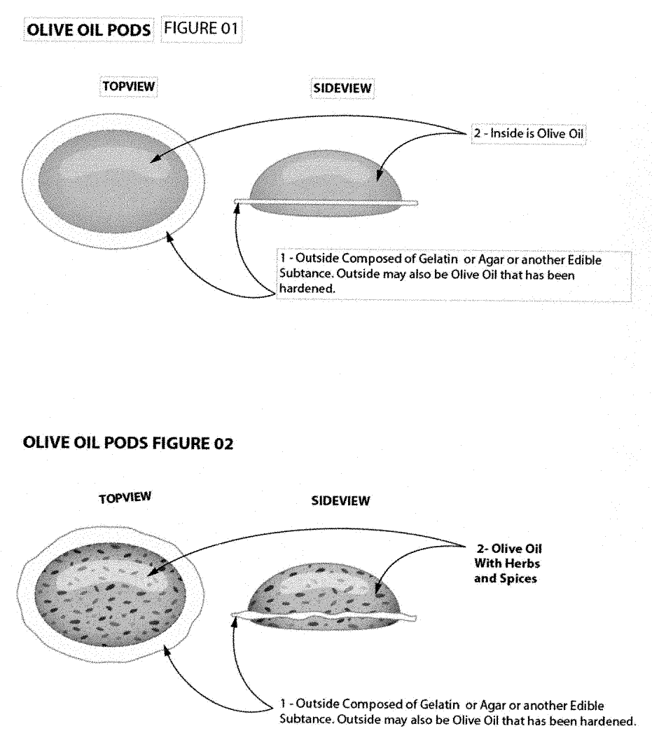

1=A gelatin, agar agar, or other edible gelatin substance that is used to encapsulate the inside substance.

2=Olive Oil is combined with herbs and spices and is the inside substance of the encapsulated gelatin pod.

### DETAILED DESCRIPTION OF THE INVENTION

There is no other invention like this one the market. This is not an improved product patent either. The process is simple with existing ingredient on the market. Gelatin is a widely used product available from hundreds of sources. Gelatin will be put into a mold, olive oil and herbs infused, and then it will be set to cure. This is a very simple process that requires no special equipment or machinery. All ingredients are on the market currently so it's a matter of assembling, molding and curing. The mold is a very basic mold. A syringe can be used to inject the olive oil and spices. Each pod will have its own herbs or spices inside. For instance there will be a garlic and olive oil pod; a basil and olive oil pod, or a thyme and olive oil pod. Any herb can be infused in the olive oil pods. The list above is just a small sample of the variations of olive oil pods that can be created.

1. A capsule or pod in which is either olive oil or gelatin on the outside and the inner composition is filled with olive oil and spices and herbs. The capsule or pod is clear on the outside, with the visual appearance of olive oil on the inside with herbs in the inside:
(a) center core is comprised of olive oil and any and all types of fresh and dried herbs and spices, and
(b) the outside is comprised of a gelatin food based product which is also known as food based gelatin (or olive oil gelatin), and
(c) the shape may be round, oblong, square depending on the spices used.
